(19) United States
(12) Patent Application Publication
(10) Pub. No.: US 2015/0158537 A1
(43) Pub. Date: Jun. 11, 2015

(54) SCOOTER STAND

(71) Applicant: Hunter Haitbrink, Corona, CA (US)

(72) Inventor: Hunter Haitbrink, Corona, CA (US)

(21) Appl. No.: 14/563,973

(22) Filed: Dec. 8, 2014

Related U.S. Application Data
(60) Provisional application No. 61/913,221, filed on Dec. 6, 2013.

(51) Int. Cl. B62H 3/08; F16M 11/04; B62M 1/00

(52) U.S. Cl. CPC B62H 3/08; B62M 1/00; F16M 11/04

(57) ABSTRACT

A scooter stand, in accordance with the present invention, comprises at least one wheel receptacle and a deck receptacle. In one exemplary embodiment, the scooter stand comprises a front and a back wheel receptacle, in addition to a deck receptacle, wherein the three receptacles are on the same horizontal plane. The front and back wheel receptacles are configured to receive a scooter's front and back wheel, respectively. The deck receptacle is configured to receive the deck of a scooter, meaning the place where a user places one or both feet when propelling forward or passively riding the scooter. In exemplary embodiments, the device has a front and back stand for lifting the receptacles and the scooter off the ground. The front stand will ideally have a side support with walls above it, whereby a scooter has a secondary means of remaining upright within the scooter stand.

### TECHNICAL FIELD OF THE INVENTION

The present invention relates in general to a scooter stand and more specifically to a stand for storing a scooter upright and in a fixed position. The invention offers a means of neatly storing scooters in order to conserve space and keep the scooters from damage associated with leaving scooters on the ground or leaning them against a wall or surface.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Scooters are typically two-wheeled apparatus wherein a user can propel forward using their foot, and hold and operate a handle for balance and direction. The push scooter is thought to be a hybrid of the bicycle and skateboard. Much like bicycles and skateboards, the scooter can take up crucial space in a garage or other storage locations as a result of the awkward shape and lack of balance in the design—that is, scooters cannot balance upright unassisted. Thus, a push scooter must be stored next to a wall or another stationary or stable object if it is to remain upright. Even this requires the scooter to lean uncooperatively against the wall, as the long steering tube and finicky handle can cause the scooter to become disengaged from the wall and crash to the floor.

As most parents can attest to, the alternative to placing a scooter against the wall is even less appealing. Once finished riding their scooter, a child may instead place the scooter on the ground in the garage or in the front or back yard, contributing to a cluttered and unsightly mess and introducing a dangerous tripping hazard for those in the vicinity.

Therefore, there is a need in the art for a scooter stand which allows a scooter to be stored in a reliably upright position in any location. It is to these ends that the present invention has been developed.

### BRIEF SUMMARY OF THE INVENTION

To minimize the limitations in the prior art, and to minimize other limitations that will be apparent upon reading and understanding the present specification, the present invention describes a scooter stand for securing a scooter in an upright position.

A scooter stand, in accordance with one embodiment of the present invention, comprises: a deck receptacle including a front end and a back end, the deck receptacle having a length substantially greater than a width; one or more wheel receptacles configured to register with a wheel of a scooter; and a deck support, the deck support maintaining at least a portion of the one or more wheel receptacles above the ground.

A scooter stand, in accordance with another embodiment of the present invention, comprises: a deck receptacle including a front end and a back end, the deck receptacle having a length substantially greater than a width; a front wheel receptacle situated at the front end of the deck receptacle, and a back wheel receptacle situated at the back end of the deck receptacle, wherein the front wheel receptacle and the back wheel receptacle are positioned along a longitudinal center of the deck receptacle and include an opening, a top edge, an inner surface, and a bottom portion configured to register with a wheel of a scooter; and a deck support, the deck support maintaining the bottom portion of the front and back wheel receptacles above the ground.

A scooter stand, in accordance with yet another embodiment of the present invention, comprises: a deck receptacle including a front end and a back end, the deck receptacle including: a length substantially greater than a width, lateral support walls at the front end, the lateral support walls substantially parallel to each other, a front support wall situated between and perpendicular to the two lateral support walls; a front wheel receptacle situated at the front end of the deck receptacle, and a back wheel receptacle situated at the back end of the deck receptacle, wherein the front wheel receptacle and the back wheel receptacle are positioned along a longitudinal center of the deck receptacle; and a deck support, the deck support maintaining the bottom portion of the front and back wheel receptacles above the ground, wherein the deck support includes: a front support member situated beneath the front end of the deck receptacle, a back support member situated beneath the back end of the deck receptacle, the front and back support members having equal heights so that a surface of the deck receptacle is parallel to the ground.

It is an objective of the present invention to provide a means with which to store a scooter in any location.

It is another objective of the present invention to secure a scooter in an upright position.

It is yet another objective of the present invention to provide a simple, effective alternative to leaving a scooter on the ground or leaning it against a stationary object.

These and other advantages and features of the present scooter stand are described herein with specificity so as to make the present invention understandable to one of ordinary skill in the art.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the scooter stand. Furthermore, elements that are known to be common and well understood to those in the industry are not depicted in order to provide a clear view of the various embodiments of the invention.

FIG. 1 is a perspective view of a scooter secured within a scooter stand, in accordance with an exemplary embodiment of the present invention.

FIG. 2(a) is a top perspective view of a scooter stand, in accordance with an exemplary embodiment of the present invention.

FIG. 2(b) is a side view of one embodiment of a scooter stand in accordance with the present invention.

FIG. 2(c) is a back view one embodiment of a scooter stand in accordance with the present invention.

FIG. 2(d) is a top view of t one embodiment of a scooter stand in accordance with the present invention.

### DETAILED DESCRIPTION OF THE INVENTION

In the following discussion that addresses a number of embodiments and applications of the present scooter stand, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

Generally, a scooter stand in accordance with the present invention comprises a wheel receptacle and a deck receptacle configured to receive one or more components of a scooter in order to hold the scooter in an upright position. In one exemplary embodiment, a scooter stand comprises a front and a back wheel receptacle, and a deck receptacle, wherein the three receptacles are on the same horizontal plane; this may be desirable to allow the scooter to stand upright without tipping without requiring the wheels to be touching the ground. The front wheel receptacle may be configured to receive a scooter's front wheel and the back wheel receptacle may be configured to receive a scooter's back wheel. The deck receptacle may be configured to receive the deck of a scooter, meaning the place where a user places one or both feet when propelling forward or passively riding the scooter. In exemplary embodiments, the device may include a front and back support for the deck receptacle, which keeps the scooter off the ground. The front end of the deck receptacle may include side support walls whereby a scooter has a secondary means of remaining upright within the scooter stand. Typically, the scooter stand is shaped compactly so that it may be easily tucked away into the corner of a room, closet, garage, front yard, back yard, or the like.

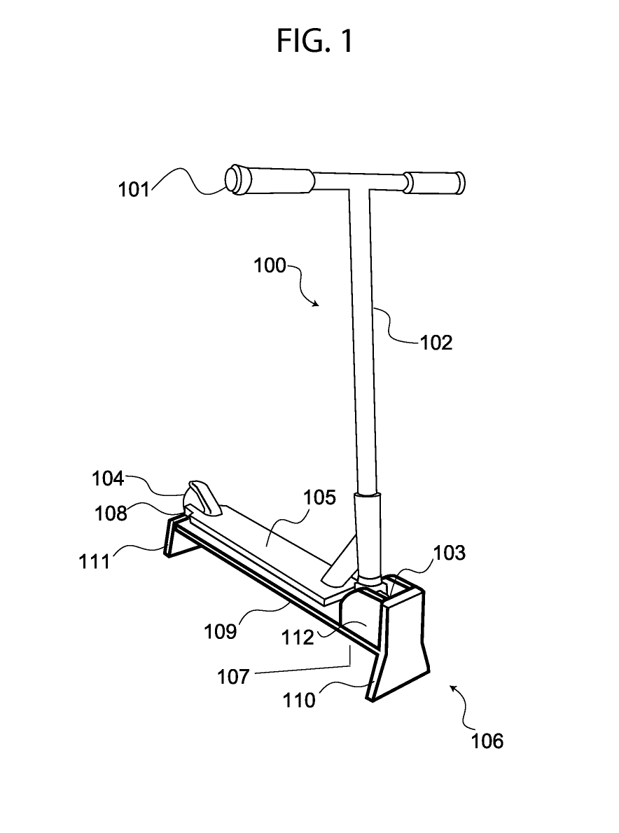

Turning now to the figures, FIG. 1 is a perspective view of a scooter secured within a scooter stand, in accordance with an exemplary embodiment of the present invention. Scooter 100 may be any typical scooter commonly known in the art; scooter 100 comprises handle 101, steering tube 102, front wheel 103, back wheel 104, and deck 105. Scooter 100 may also comprise other components, such as a brake or even an electric motor, thus scooter 100 may be any scooter having at least two wheels and a deck. Additionally, the scooter is not limited to being a push scooter, as it may also be an electric or motorized scooter. In any case, one or more embodiments of the present invention may be configured to secure a wide variety of scooters known in the art.

By way of a non-limiting example, the present invention may secure a Razor™ or other similar scooter. Handle 101 sits atop scooter 100 and is responsible for the handling, steering, and balance of scooter 100. Thus, handle 101 may twist to alter the directionality of scooter 100. Because handle 101 is the topmost component of scooter 100, handle 101 is the part of scooter 100 which leans, for instance, against a wall. Steering tube 102 serves as the vertical transition region between handle 101 and the horizontal bottom region of scooter 100. The bottom of scooter 100 comprises front wheel 103, back wheel 104, and deck 105. Unfortunately, because of its movability, handle 101 is a non-ideal component to lean against the wall. Often, when a scooter is leaned against a wall, this moving component of the typical design of a scooter causes the scooter to fall. In order to prevent this, a scooter stand in accordance with the present invention may be utilized.

A scooter stand in accordance with the present invention includes a deck receptacle for receiving the deck of scooter, one or more wheel receptacles for registering with at least one of the wheels of the scooter, and deck supports that maintain at least a portion of the one or more wheel receptacles above the ground. More specifically, in the embodiment shown, scooter stand 106 comprises front wheel receptacle 107, back wheel receptacle 108, deck receptacle 109, front deck support 110, back deck support 111, and lateral or side supports 112.

Front wheel 103 and back wheel 104 are secured by scooter stand 106. Specifically, front wheel 103 and back wheel 104 are secured by front wheel receptacle 107 and back wheel receptacle 108, respectively. Front wheel 103 is placed into front wheel receptacle 107, causing front wheel 103 to partially protrude from the bottom of scooter stand 106, removing the ability of front wheel 103 to propel scooter 100 forward by rolling. Similarly, back wheel 104 is place into back wheel receptacle 108, causing back wheel 104 to partially protrude from the bottom of scooter stand 106, also removing the ability of back wheel 104 to propel scooter 100 forward by rolling.

Additionally, deck 105 of scooter 100 rests on the surface of deck receptacle 109, which adds additional stability to scooter 100. Accordingly, scooter 100 is relegated to the preferred upright position until removed from scooter 106 by a user. In the exemplary embodiment illustrated in FIG. 1, deck receptacle 109 comprise a flat planar member running substantially parallel to deck 105. In an alternative embodiment, deck receptacle 109 of scooter stand 106 comprises a protruding member higher than the rest of deck receptacle 109. In this embodiment, the opening sometimes present along the length of a scooter's deck will be filled by the protruding member, granting an even greater degree of stability to scooter 100.

Front deck support 110 and back deck support 111 reside in front of front wheel receptacle 107 and in back of back wheel receptacle 108, respectively. Front and back deck supports 110, 111 lift scooter stand 106 off the ground so that when scooter 100 is placed within scooter stand 106, front wheel 103 and back wheel 104 cannot begin rolling along the ground. Moreover, because front wheel 103 is secured in front wheel receptacle 107, steering tube 102 will be prevented from turning Furthermore, since deck 105 rests atop of deck receptacle 109, scooter 100 will stand upright and in a fixed position.

Front and back deck supports 110, 111 allow for front and back wheels 103, 104 to protrude below deck receptacle 109 since both wheel receptacles have openings for registering with the scooter's wheels. In this embodiment, front deck support 110 and back deck support 111, front wheel 103 and back wheel 104 allow the wheels of the scooter to sufficiently protrude below deck receptacle 109 and maintain the scooter and scooter stand stable. Furthermore, scooter stand 106 may also comprise of lateral or side supports 112. Side supports 112 may be an additional stabilizer for scooter 100 by providing heightened walls to stop front wheel 103 or the bottom of steering tube 102 from tipping too severely.

Some scooters bend near the junction between deck 105 and steering tube 102 and may thus be folded downward to minimize the height of the scooter for ease of storage. In this case, steering tube 102 runs approximately parallel to deck 105. In accordance with the present invention, a folded scooter just as easily utilizes scooter stand 106 to maintain balance and upright storage.

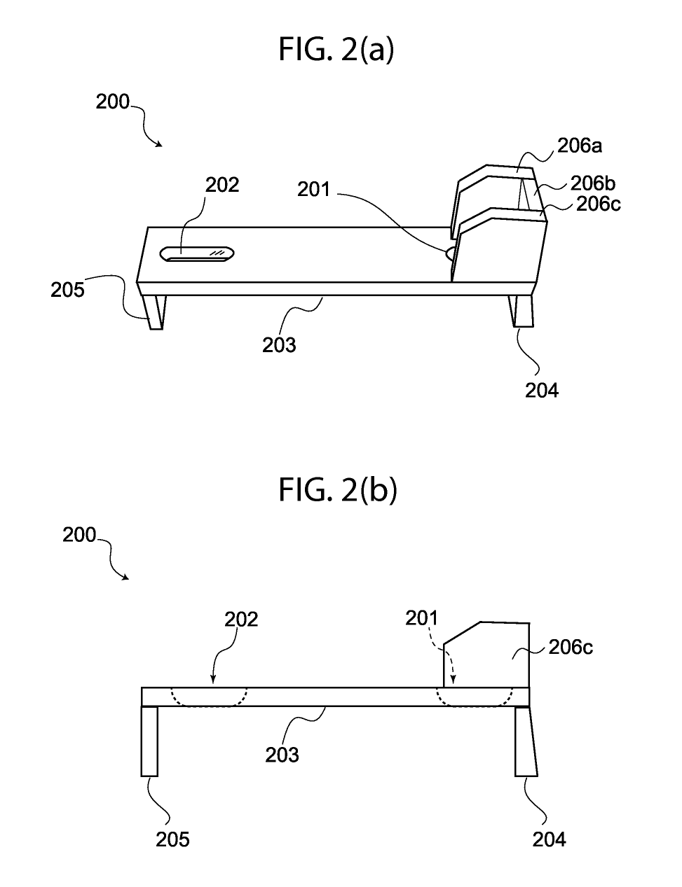

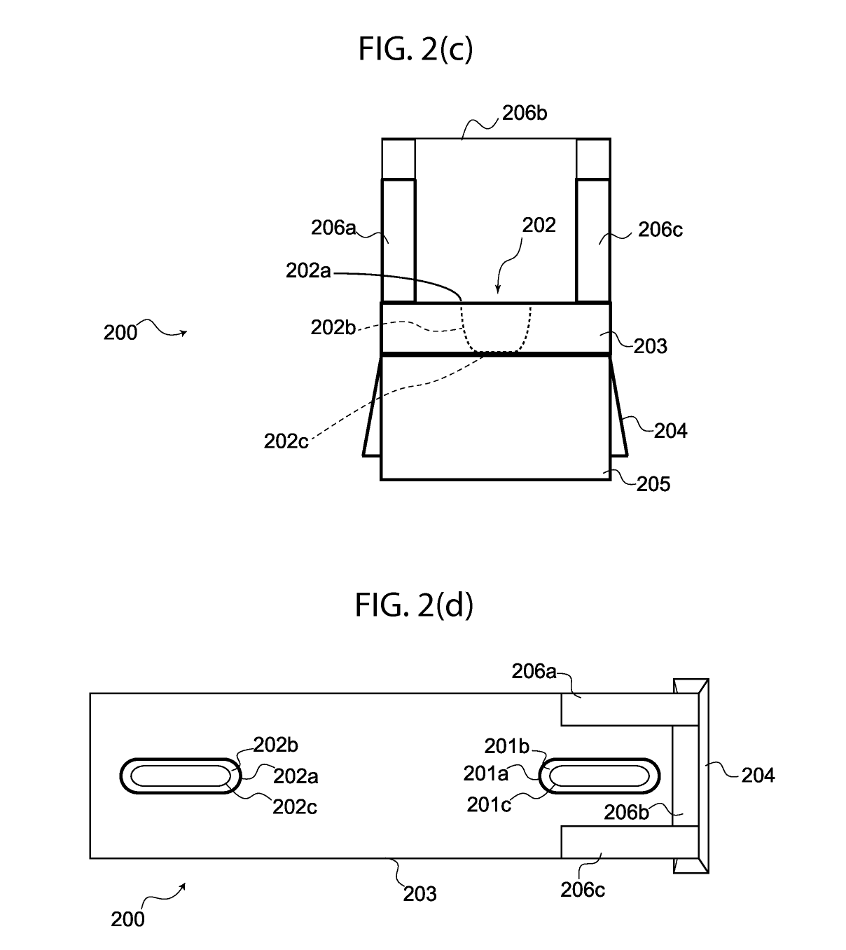

FIG. 2(a) is a top perspective view of a scooter stand in accordance with an exemplary embodiment of the present invention. Scooter stand 200 may be constructed of any material that is rigid, durable and suitable to hold the weight of a typical scooter. That is, scooter stand 200 may be constructed of metal, wood, plastics, or any other material or combination of materials without deviating from the scope of the present invention. Furthermore, scooter stand 200 is typically shaped with a greater length than width, wherein the one or more wheel receptacles may be situated along a center longitudinal line of the body or deck of the scooter stand.

Scooter stand 200 comprises of front wheel receptacle 201, back wheel receptacle 202, deck receptacle 203, front support 204, back support 205, and side support walls 206a, 206b, and 206c.

Front wheel receptacle 201 and back wheel receptacle 202 are roughly elliptical holes or openings aligned on the surface of deck receptacle 203. Wheel receptacles 201, 202 may be designed to proportionally approximate the length and width of a scooter wheel so that the scooter's wheels may register with the openings or be easily contained within front and back wheel receptacles 201, 202. The aforementioned proportionality of receptacles 201, 202 refers to the slightly larger dimensions of receptacles 201, 202 as compared to the wheels of a scooter, whereby numerous different types of scooters with varying wheel sizes may still utilize the scooter stand 200. As will be discussed below, wheel receptacles may have a variety of shapes and configurations without deviating from the scope of the present invention. For example, in one embodiment, front and back wheel receptacles 201, 202 are not through opening, but are rather indents with a predetermined depth so that a portion of a scooter's front and back wheels can fit into the indent before reaching a solid material beneath.

Deck receptacle 203 may be constructed of any durable material as discussed above with relation to the entire apparatus; for example, deck receptacle may be constructed of wood, plastic, metal, or any known material or multiple materials so long as its construction is durable and preferably light weight. Of course, although lightweight construction is desirable, the weight should not be so light so as to lose stability when a scooter is placed atop the stand.

Deck receptacle 203 includes a front end and a back end, wherein the length between the front end and the back end is greater than a width of deck receptacle 203. This configuration is desirable because a scooter is typically similarly shaped, wherein the scooter includes a deck with a small width and a larger length, the wheels of the scooter aligned along the longitudinal center of the scooter's deck. Hence, deck receptacle 203 is typically configured to receive a deck of a scooter, and register with one or more wheels of the scooter and thus should have a shape that complements the overall shape of a scooter. For example, and without limitation, deck receptacle 203 may be rectangular in shape.

Although in the embodiment shown deck receptacle 203 includes both front and back wheel receptacles, alternative embodiments may include a single wheel receptacle. For example, and without deviating from the scope of the present invention, deck receptacle 203 may only include wheel receptacle 201. In such embodiment, with a single wheel receptacle, the length of deck receptacle 203 may be shorter so that a second wheel of a scooter may hang on the shorter back end of the deck receptacle; alternatively, only the front portion of a scooter, including only the front wheel, may rest on such a stand, and thus the deck receptacle may be a small component that only accommodates the front end of the scooter.

Having two wheel receptacles as shown may be desirable to provide added sturdiness, which may be diminished by a hanging wheel; a scooter that is stationed and secured with two wheel receptacles will be much more difficult to push over or slide off deck receptacle 203.

In the shown embodiment, deck receptacle includes support members 204 and 205 as well as lateral support walls 206a and 206c, and front end support wall 206b. Supports 204 and 205 provide stability and allow the wheel receptacles to be raised above the ground; lateral support walls 206a and 206c, and front end support wall 206b may provide an additional support structure that further prevents a scooter's steering tube from tilting one way or the other—as discussed above with reference to FIG. 1.

FIG. 2(b) is a side view of the scooter stand in accordance with the exemplary embodiment depicted in FIG. 2(a). In this figure, it can be appreciated that wheel receptacle 201 is situated towards the front of the scooter stand and mostly surrounded by the side supports and front support. Furthermore, supports 204 and 205 significantly raise the deck above the ground.

Supports 204 and 205 are shown as separate entities—one on the front end and the other on the back end—however a single support structure may replace both supports in alternative embodiments wherein a single support structure may, for example, support an entire perimeter of deck receptacle 203. In yet other embodiments, multiple support structures, much like pegs or legs of a table, may be implemented in order to support deck receptacle 203 above the ground. Furthermore, although supports 204 and 205 have equal heights and hold deck receptacle 203 parallel to the ground, in alternative embodiments, these supports may hold deck receptacle 203 at an incline without deviating from the scope of the present invention. One advantage of providing supports 204 and 205, or alternative embodiments therein, is that wheel receptacles 201 and 202 may be raised, allowing wheels of a scooter placed on the stand to snuggly fit or register with the wheel receptacle—typically by protruding through a bottom portion or opening of each wheel receptacle.

Turning to the next figures now, FIG. 2(c) is a back view of scooter stand 200, where additional features of the elements or components of the stand may be appreciated; FIG. 2(d) shows a top view of scooter stand 200 further depicting the various elements and features discussed above. Particularly, support 204 is depicted extending further out than the front portion of deck receptacle 203, and the wheel receptacles are shown including different sized openings for receiving or registering with the wheels of a scooter.

In this embodiment, support 204 widens at the bottom or base that contacts the ground, for example having a trapezoidal shape—this may be desirable for stability, although in alternative embodiments, support 204 may be of an equal width from base to top, matching a width of deck receptacle 203. Alternative variations of support 204's width would not deviate from the scope of the invention, however it is desirable that whatever the parameters of support 204 or 205, they provide stability and are capable of supporting the weight of deck receptacle 203 an a typical scooter. Similarly, although support 205 is shown with a consistent width from its base to the deck receptacle, alternative variations may be implemented without deviating from the scope of the present invention.

This view also depicts wheel receptacle 202, which includes a top portion or top edge 202a, an inner surface 202b, and a bottom portion or bottom edge 202c. This configuration of wheel receptacle 202 allows a wheel of a scooter to register with deck receptacle 203 securely. In this embodiment, wheel receptacle 202 includes an opening outlined by top edge 202a and situated on a top surface of deck receptacle 203. Below top edge 202a, bottom edge 202c may include an additional opening situated on a bottom surface of deck receptacle 203, bottom portion connected to the top portion with an inner surface 202b. In the embodiment shown, inner surface 202b is curved in a manner so that the bottom edge or bottom portion of wheel receptacle 202 has a smaller elliptical perimeter than top edge 202a—this may be desirable so that the wheel receptacle holds a scooter's wheels more snuggly. However, in alternative embodiments, wheel receptacles 201 and 202 may include top edges and bottom edges with equal perimeters, and rectal inner surfaces—this may provide a wider range of compatibility with different size wheels of different types of scooters.

A scooter stand has been described. The foregoing description of the various exemplary embodiments of the scooter stand has been presented for the purposes of illustration and disclosure. It is not intended to be exhaustive or to limit the invention to the precise form disclosed. Many modifications and variations are possible in light of the above teaching without departing from the spirit of the invention.

### DESCRIPTION OF THE REFERENCE SYMBOLS

100: Scooter

101: Handle

102: Steering tube

103: Front wheel

104: Back wheel

105: Deck

106: Scooter stand

107: Front wheel receptacle

108: Back wheel receptacle

109: Deck receptacle

110: Front deck support

111: Back deck support

112: Side supports

200 Scooter stand

201: Front wheel receptacle

201a: Top portion

201b: inner surface

201c: bottom portion

202: Back wheel receptacle

202a: Top portion

202b: inner surface

202c: bottom portion

203: Deck receptacle

204: Front support

205: Back support

206a: Side support wall

206b: Front support wall

206c: Side support wall

What is claimed is:

1. A scooter stand, comprising:
a deck receptacle including a front end and a back end, the deck receptacle having a length substantially greater than a width;
one or more wheel receptacles configured to register with a wheel of a scooter; and
a deck support, the deck support maintaining at least a portion of the one or more wheel receptacles above the ground.

2. The scooter stand of claim 1, wherein one of the one or more wheel receptacles includes a front wheel receptacle situated at the front end of the deck receptacle.

3. The scooter stand of claim 2, wherein one of the one or more wheel receptacles includes a back wheel receptacle situated at the back end of the deck receptacle.

4. The scooter stand of claim 3, wherein the front wheel receptacle and the back wheel receptacle are positioned along a longitudinal center of the deck receptacle.

5. The scooter stand of claim 1, wherein the one or more wheel receptacles include an opening, a top edge, an inner surface, and a bottom portion.

6. The scooter stand of claim 5, wherein the top edge includes a perimeter that is larger than the perimeter of the bottom portion, and the inner surface is a curved surface configured to snuggly receive a wheel of a scooter.

7. The scooter stand of claim 6, wherein the bottom portion includes a second opening for receiving a bottom portion of a scooter wheel.

8. The scooter stand of claim 5, wherein the top edge and the bottom portion have equal perimeters.

9. The scooter stand of claim 8, wherein the bottom portion includes a second opening for receiving a bottom portion of a scooter wheel.

10. The scooter stand of claim 1, wherein the deck receptacle includes lateral support walls at the front end, the lateral support walls substantially parallel to each other and along each side of one of the one or more wheel receptacles.

11. The scooter stand of claim 10, wherein the deck receptacle includes a front support wall situated between and perpendicular to the two lateral support walls at the front end of the deck receptacle.

12. The scooter stand of claim 1, wherein the deck support includes a front support member situated beneath the front end of the deck receptacle.

13. The scooter stand of claim 12, wherein the deck support further includes a back support member situated beneath the back end of the deck receptacle.

14. The scooter stand of claim 13, wherein the front and back support members have equal heights so that a surface of the deck receptacle is parallel to the ground.

15. The scooter stand of claim 12, wherein the front support member has a greater width than the deck receptacle.

16. The scooter stand of claim 12, wherein the front support member has a trapezoidal shape.

17. The scooter stand of claim 12, wherein the back support member has a greater width than the deck receptacle.

18. The scooter stand of claim 12, wherein the front and back support members have a greater width than the deck receptacle.

19. A scooter stand, comprising:
a deck receptacle including a front end and a back end, the deck receptacle having a length substantially greater than a width;
a front wheel receptacle situated at the front end of the deck receptacle, and a back wheel receptacle situated at the back end of the deck receptacle, wherein the front wheel receptacle and the back wheel receptacle are positioned along a longitudinal center of the deck receptacle and include an opening, a top edge, an inner surface, and a bottom portion configured to register with a wheel of a scooter; and
a deck support, the deck support maintaining the bottom portion of the front and back wheel receptacles above the ground.

20. A scooter stand, comprising:
a deck receptacle including a front end and a back end, the deck receptacle including:
a length substantially greater than a width,
lateral support walls at the front end, the lateral support walls substantially parallel to each other,
a front support wall situated between and perpendicular to the two lateral support walls;
a front wheel receptacle situated at the front end of the deck receptacle, and a back wheel receptacle situated at the back end of the deck receptacle, wherein the front wheel receptacle and the back wheel receptacle are positioned along a longitudinal center of the deck receptacle; and
a deck support, the deck support maintaining the bottom portion of the front and back wheel receptacles above the ground, wherein the deck support includes:
a front support member situated beneath the front end of the deck receptacle,
a back support member situated beneath the back end of the deck receptacle, the front and back support members having equal heights so that a surface of the deck receptacle is parallel to the ground.
